(19) United States
(12) Patent Application Publication
(10) Pub. No.: US 2018/0128313 A1
(43) Pub. Date: May 10, 2018

(54) ACTIVE RADIAL MAGNETIC BEARING PHASED ARRAY

(71) Applicant: Cleveland State University, Cleveland, OH (US)

(72) Inventors: Jerzy T. Sawicki, Westlake, OH (US); Kenneth R. Bischof, Arden, NC (US)

(73) Assignee: Cleveland State University, Cleveland, OH (US)

(21) Appl. No.: 15/344,886

(22) Filed: Nov. 7, 2016

(51) Int. Cl. F16C 32/04

(52) U.S. Cl. CPC F16C 32/048; F16C 2233/00; F16C 32/0446; F16C 32/0453

(57) ABSTRACT

A rotor bearing system radially supporting a rotor, held in magnetic suspension without contact, by active radial magnetic bearing phased arrays, bearing sensors used to measure the rotor motion and bearing properties, a controller system used to adjust variable magnetic bearing parameters via amplifiers for each array element in response to bearing sensors, to change bearing local array element stiffness and damping, generating bearing forces for levitating the rotor, stabilizing rotor vibrations, and acting as a rotor vibration actuator.

### BACKGROUND

The present disclosure relates to improvements in active magnetic bearing assemblies and systems. More particularly, the present disclosure relates to an active magnetic bearing assembly and system having a plurality of electromagnet segments arranged in a phased axial array to support a rotor using magnetic levitation. However, it is to be appreciated that the present exemplary embodiment is also amenable to other like applications.

Generally, magnetic bearing assemblies are utilized to support moving parts of a system such as a rotor without physical contact due to magnetic levitation. For instance, they are able to levitate a rotating shaft and to permit relative motion with very low friction without mechanical wear of the shaft.

Magnetic bearings are considered to be “active” if they include electromagnets and are considered “passive” when the magnets are permanent. Active magnetic bearings typically include an assembly having electromagnets arranged radially about a rotor, a set of power amplifiers to supply current to the electromagnets, a controller unit, and a displacement sensor to provide signals that identify the position of the rotor within the assembly. The electromagnets of active magnetic bearing assemblies require continuous power input and a control system to maintain the stability of the rotor in an optimal position.

Generally, active magnetic bearing assemblies do not suffer from wear, have very low and/or predictable friction, include the ability to run without lubrication and can be operated within a vacuum environment. Magnetic bearings can be used in industrial machines such as compressors, turbines, pumps, motors and generators and be employed in various industrial applications including petroleum refinement, electrical power generation, natural gas handling as well as various submersible operations.

However, conventional magnetic bearings suffer from inaccurate rotordynamic modeling of the rotor shaft assembly and are unable to correctly account for stiffness contributions of shrunk-fit components onto the rotor shaft. Typically, the rotor shaft stiffness is incorrectly estimated such that the bearing and rotor assembly results in misplaced radial bearing axial location, i.e. the radial bearing's center of actuation may act on a modal node of the rotor shaft thereby resulting in poor efficiency or minimal controllability.

Additionally, conventional radial magnetic bearings are unable to adequately adjust to changing parameters due to the environment of the application. For example, in a machine tool spindle application in which various tools can be attached to the rotor, conventional active magnetic bearings are not robust enough to deal with a variety of tool members that can be attached to the same spindle due to various tool masses that might be used. Another example of a changing parameter would be large industrial air handlers and fans that collect dirt on the fan blades causing unbalance in the rotatable mass of the fan over time. Generally, conventional radial magnetic bearings are not robust enough to these parameter changes.

Further, an application such as a fly-wheel energy storage device that is supported on active radial magnetic bearings may experience adjustable rotational inertia that is speed dependent. The energy in this application is stored in a large rotating disk (flywheel). The rotor shaft slows down in conventional constant shape flywheel designs, but the adjustable rotational inertia flywheel would have a disk that reduces the outer diameter of the disk during rotation causing the disk to maintain speed for a longer time until the disk cannot reduce size any longer due to the conservation of angular momentum. This example is similar to an ice skater spinning with arms out, then as the arms are brought inwards, the rotational speed of the skater increases for a period of time. Conventional magnetic bearings would not be robust enough to account for rotational inefficiencies caused by applications having various or changing rotational inertia or other application parameters.

Conventional radial magnetic bearings have relatively limited ability to adjust for modified parameters such as due to vibration signatures and offer limited ability to accommodate irregularities in the mass distribution of the rotor during rotation. Many of the industrial uses for active magnetic bearings provide for limited ability to stabilize rotor vibrations or other irregularities due to mass distribution of the rotor during operation.

Therefore, there is a need to provide a magnetic bearing assembly and system that is capable of providing fine adjustments during rotor operation to correct irregularities and to stabilize rotor vibrations. Further, there is a need for a bearing design that has the ability to axially shift the radial support location axially along the rotor either inwardly or outwardly during the operation of the rotor to avoid a modal node of the rotor shaft for a particular application. Additionally, there is a need for a bearing assembly that would allow a much larger range of rotor unbalance that might be satisfactorily dealt with before machine shut down.

### BRIEF DESCRIPTION

In accordance with one aspect of the present exemplary embodiment, provided is a magnetic bearing assembly for supporting a rotor. The magnetic bearing assembly includes a stator configured to receive the rotor allowing the rotor to rotate along an axis of rotation and a plurality of electromagnetic solenoid segments arranged in a phased axial array that is axially aligned in a lengthwise manner relative to the axis of rotation and supported by the stator. Each of the plurality of electromagnet segments include at least one core and coil member. A controller is configured to individually control each of the electromagnetic solenoid segments to adjust a magnetic flux force vector of the bearing assembly such that a support point can be axially shifted along the magnetic bearing assembly. At least one feedback sensor is provided to measure an air gap between the rotor and at least one of the plurality of electromagnetic solenoid segments and provide a signal to the controller such that the controller is adapted to individually adjust the magnetic flux force vector produced by each of the plurality of electromagnetic solenoid segments.

In accordance with another embodiment, provided is a magnetic bearing system for supporting a rotor. The system includes a first stator configured to receive an elongated rotor adapted to rotate along an axis of rotation. A plurality of electromagnetic solenoid segments are supported by the first stator and arranged in a phased axial array. A second stator is spaced from the first stator and configured to receive the elongated rotor and is adapted to rotate along the axis of rotation. A plurality of electromagnetic solenoid segments are supported by the second stator and arranged in a phased axial array. A controller is in individual electrical communication with each of the electromagnetic solenoid segments and is configured to individually control each of the electromagnetic solenoid segments to adjust a magnetic flux force vector of the first stator and the second stator of the magnetic bearing system.

### BRIEF DESCRIPTION OF THE DRAWINGS

FIG. 1 is a schematic plan view of a rotor radially supported by conventional active radial magnetic bearings;

FIG. 2 is a schematic plan view of a one embodiment of the magnetic bearing assembly and a rotor that is radially supported by electromagnetic solenoid segments aligned in a phased axial array according the present disclosure;

FIG. 3 is an enlarged plan view of the rotor supported at one end by a single conventional active radial magnetic bearing;

FIG. 4 is an enlarged schematic plan view of the magnetic bearing assembly of FIG. 2;

FIG. 5A is a schematic end view of one embodiment of the magnetic bearing assembly and rotor according to the present disclosure;

FIG. 5b is schematic end view of another embodiment of the magnetic bearing assembly and rotor according to the present disclosure;

FIG. 6 is an enlarged schematic view of the conventional radial magnetic bearing of FIG. 1 illustrating a force vector axial location;

FIG. 7 is an enlarged schematic view of the magnetic bearing assembly of FIG. 2 of the present disclosure illustrating a force vector;

FIG. 8 is an enlarged schematic view of the magnetic bearing assembly of FIG. 2 of the present disclosure illustrating the force vector axially skewed inboard (right);

FIG. 9 is an enlarged schematic view of the magnetic bearing assembly of FIG. 2 of the present disclosure illustrating the force vector axially skewed outboard (left); and

FIG. 10 is a schematic view of the magnetic bearing system according to one embodiment of the present disclosure.

### DETAILED DESCRIPTION

It is to be understood that the detailed figures are for purposes of illustrating the exemplary embodiments only and are not intended to be limiting. Additionally, it will be appreciated that the drawings are not to scale and that portions of certain elements may be exaggerated for purpose of clarity and ease of illustration.

Provided herein is a magnetic bearing assembly and system that includes a set of individual electromagnetic solenoid segments that are axially arranged into a phased array, stack or series, to form a phased axial array that partially supports a rotor shaft. The bearing assembly includes a stator housing, envelope or body that supports the electromagnetic solenoid segments in a radial orientation relative to the rotor. The phased axial array, can be configured to fit into a conventional bearing stator housing, or other configuration, as needed to support the rotor therein and allow it to rotate along an axis of rotation. Each electromagnetic solenoid segment can include a plurality of magnetic cores and coils having various shapes that are radially positioned about the circumference of the rotor. The electromagnetic solenoid segments that make up the phased axial array, are individual in the sense that each are independent from the other and can individual function as a complete radial magnetic bearing. The assembly includes a separate amplifier in communication with each electromagnetic solenoid segment and can optionally include at least one radial displacement sensor. Further, the disclosure includes a controller that can be configured to control individual magnetic bearing assemblies or be adapted to control multiple magnetic bearing assemblies where each bearing includes electromagnetic solenoid segments that are axially arranged in the phased axial array.

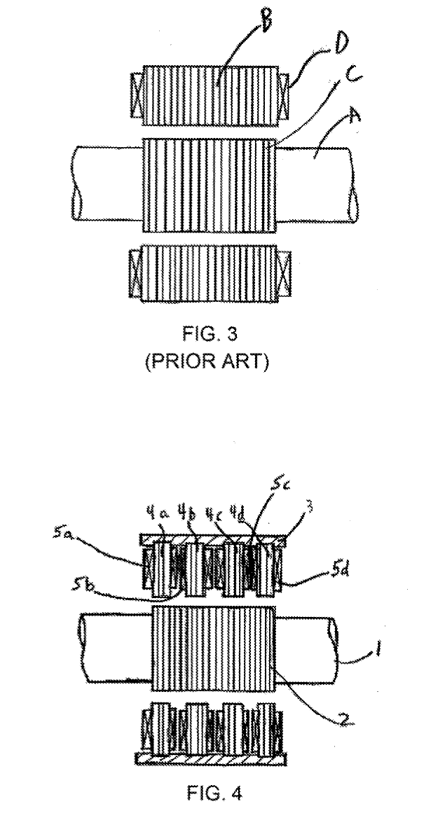

As illustrated by FIGS. 1 and 3, provided is a rotor bearing system utilizing conventional radial active magnetic bearings known in the art to constrain the rotor in the radial direction. The rotor A, which is designed as a rotating shaft, is held in magnetic suspension without contact by a pair of radial magnetic bearings stators B, each stator with coils D. Each magnetic bearing has rotor laminations C installed onto the rotor A that rotates with the rotor. FIG. 3 illustrates the conventional active magnetic bearing. Stator C is comprised of a single one axial unit and coil system D for the entire stator. Rotor A shown with rotor laminations.

Generally, to radially constrain a rotating rotor shaft section, the rotor is supported radially by two conventional radial magnetic bearings separated by some axial bearing span as required for the appropriate application. Bearing spans can be determined by rotordynamic analysis. This disclosure contemplates replacing the conventional magnetic bearings with an active radial magnetic bearing array at a bearing span along the rotor for the appropriate application. The span can be adjusted by the sum of the magnetic flux forces individually provided by each of the electromagnetic solenoid segments.

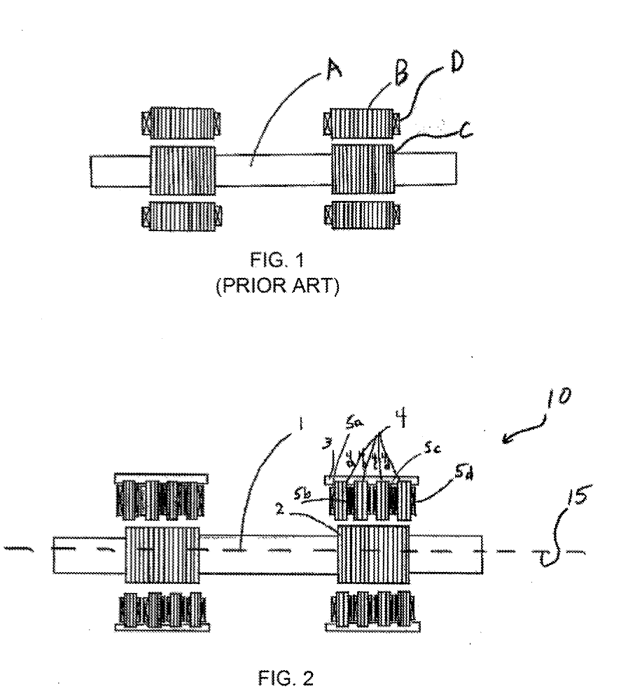

FIGS. 2 and 4 illustrate one embodiment of a magnetic bearing assembly 10 of the present disclosure. The rotor bearing assembly 10 utilizes a plurality of electromagnetic solenoid segments 4 that are configured in a radial orientation surrounding the circumference of a rotor 1 and are arranged in a phased axial array to constrain the rotor 1 in the radial direction. The rotor 1, which is designed as a rotating shaft, is held in magnetic suspension without contact by the two magnetic bearing assemblies 10.

Each assembly includes a stator housing 3 that is configured to support the solenoid segments 4a, 4b, 4c, 4d thereon. Each segment is provided with a separate core and coil member 5a, 5b, 5c, 5d that are axially spaced from each other along the stator housing 3. In this example, the bearing assembly 10 includes four electromagnetic solenoid segments arranged in the phased axial array, but can be designed to have at least two elements or more for each bearing assembly 10. Additionally, the rotor 1 includes rotor laminations 2 that are positioned onto the surface of the rotor 1 that rotates with the rotor allowing a magnetic flux to stabilize the rotor along an axis of rotation 15. The rotor 1 and rotor laminations 2 are magnetically suspended without contact by the phased array elements 4a, 4b, 4c, 4d, with separate coil systems 5a, 5b, 5c, 5d as supported by the stator housing 3. A casing 3 to support the separate phased array elements. The rotor laminations can be constructed of laminated steel sheets that are stacked or glued together on the rotor. The thickness of the laminations can be less than 1 mm and more particularly between about 0.15 mm to 0.35 mm. The laminations 2 extend along the surface of the rotor 1 to be in magnetic alignment with the plurality of solenoid segments.

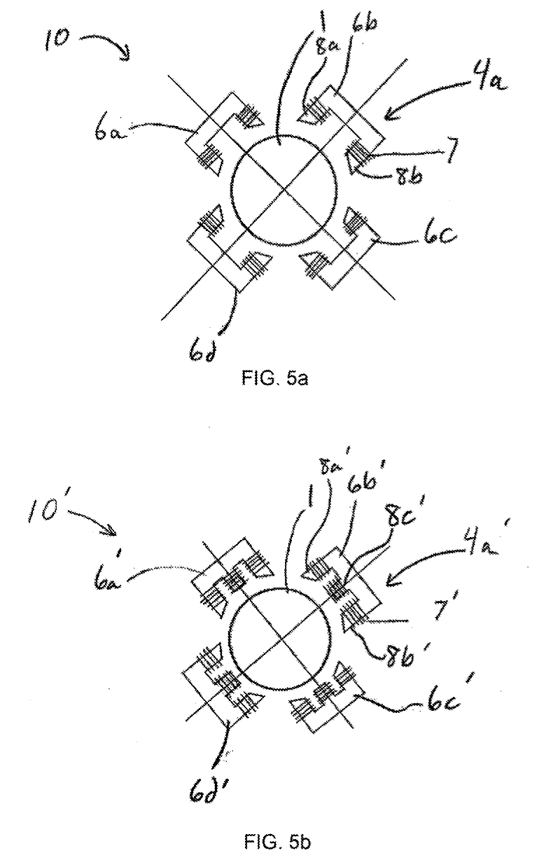

FIG. 5a illustrates one embodiment of the bearing assembly 10 identifying an end view of one of the electromagnetic solenoid segments 4a and the rotor 1. It is shown, that the electromagnetic solenoid segment 4a includes a plurality of magnet cores 6a, 6b, 6c, 6d and coils 7 that are radially arranged circumferentially around the rotor 1. Once a current is applied to the solenoid segments, the rotor 1 and rotor laminations 2 are magnetically suspended within the radially aligned core and coil members along the axis of rotation without contact.

The solenoid segments 4b, 4c and 4d can include a similar orientation in relation to segment 4a and being in common radial alignment in spaced phased axial alignment relative to the length of the rotor 1. In this embodiment, four magnet cores 6a, 6b, 6c, 6d are spaced from one another and provided in radial alignment about the rotor 1. Each are configured in a general “U” shape having a pair of opposing legs 8a, 8b in which the coils 7 are provided about each leg thereon. The core and coil member of each of the electromagnetic solenoid segments can be aligned along a common plane that is generally perpendicular to the axis of rotation. However, this disclosure is not limited in the arrangement, amount and shape of the magnetic cores as various other configurations, shapes and amounts are contemplated. For instance, the solenoid segment 4a can be radially staggered with adjacent solenoid segments 4b, 4c and 4d or can be commonly radially aligned as illustrated by FIG. 5a.

Additionally, FIG. 5b illustrates another embodiment of a magnetic bearing assembly 10′ of the present disclosure. Magnet cores 6a′, 6b′, 6c′, and 6d′ of electromagnetic solenoid segment 4a′ are arranged circumferentially around magnetically suspended rotor 1 and rotor laminations without contact. Each magnetic core includes three legs 8a′, 8b′ and 8c′ that are configured in a generally “E” shape with coils 7′ around each leg 8a′, 8b′, 8c′. Notably, various other configurations are contemplated.

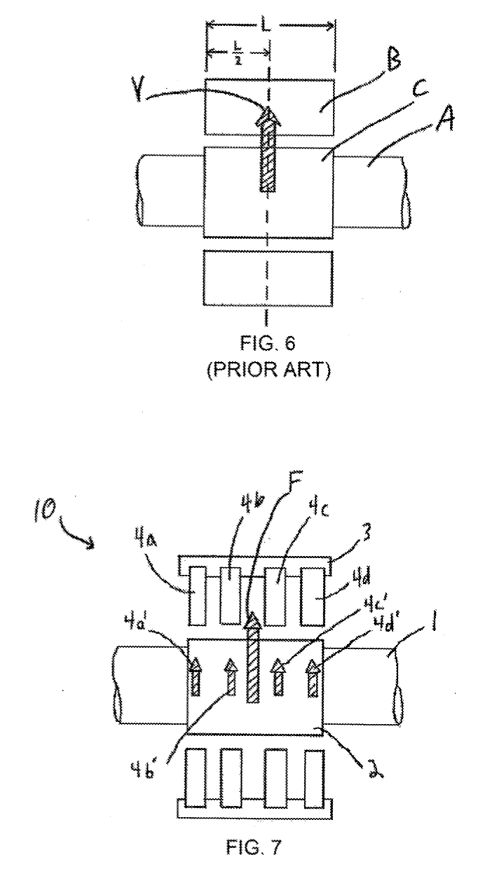

FIG. 6 illustrates the conventional active magnetic bearing and the magnetic support net force vector V that supports the rotor A. The conventional vector V is axially located typically near center of the stator B. The radial direction of the force vector V may fluctuate in magnitude and radial direction, however, the force vector V typically lies along the same axial plane location within the stator B and cannot be axially adjusted.

However, the bearing assembly 10 of the present disclosure provides a plurality of bias forces, that are collectively identified as a magnetic flux vector F. This force magnetically suspends the rotor within the magnetic bearing assembly 10 and can be electronically adjusted axially, along the length of the plurality of electromagnetic solenoid segments positioned in the phased axial array. This orientation provides a control feature takes advantage of each segment's ability to adjust the magnitude of the provided bias force to axially shift a bearing support position thereon. The axial shift of the bearing support position can depend on the desired or optimum requirements for the rotor shaft operating condition at that moment in time during operation, and can be updated at any future time automatically via a control system.

As illustrated by FIG. 7, the magnetic bearing assembly 10 with electromagnetic solenoid segments 4 aligned in the phased axial array are configured to produce magnetic support net force vector F that is axially located near center of the stator 3. Vector F is a schematic illustration of a result of the net effect of the combined force vectors 4a′, 4b′, 4c′, 4d′ of the aligned phased array of solenoid segments 4a, 4b, 4c, 4d. The radial direction of the net force vector F may fluctuate in magnitude and radial direction. The force vector F in this particular case, lays along an axial plane location within the stator 3, as a result of the efforts of the individual phased array segments 4a, 4b, 4c, 4d.

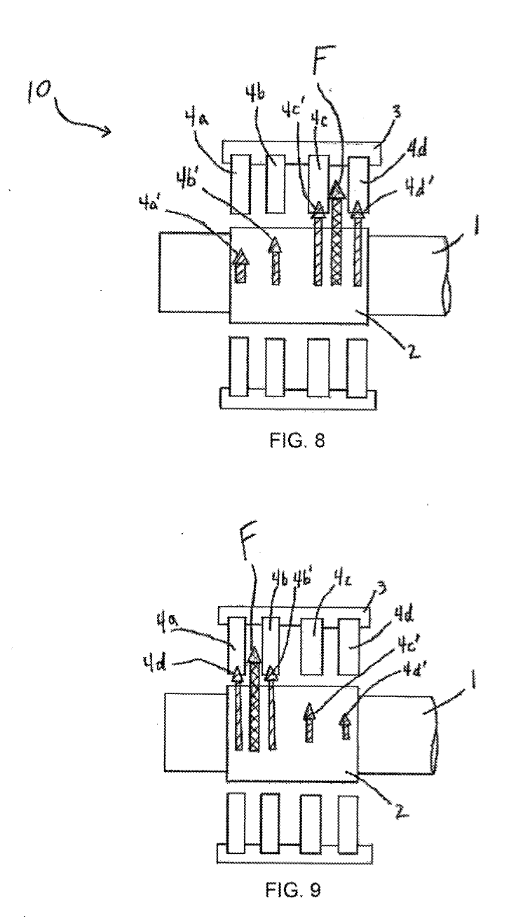

FIG. 8 illustrates that the magnetic support force vector F is positioned axially right in respect to the center of the stator 3, as a result of the net effect of the combined force vectors 4a′, 4b′, 4c′, 4d′ of array segments 4a, 4b, 4c, 4d. Similarly, as illustrated by FIG. 9, the magnetic support force vector F can be adjusted axially left in respect to the center of the stator 3, as a result of the net effect of the combined force vectors 4a′, 4b′, 4c′, 4d′ of array segments 4a, 4b, 4c, 4d. The axial location of the force vector F adjusts the support position along the rotor and can therefore adjust for minor variations in rotational inertia experienced by the rotor due to rotatable forces that act thereon.

Each bearing segment 4a, 4b, 4c and 4d of the assembly can either be independently controlled, such as with a single input single output (SISO) type controller or can be controlled by a central single control unit that oversees the complete phased axial array, such as with a multi-input multi-output (MIMO). In this embodiment the MIMO type controller includes 4 inputs and 4 outputs for 4 electromagnetic solenoid segments 4a, 4b, 4c and 4d in the bearing assembly 10. Additionally, a system with a pair of active radial bearing assemblies 10a, 10b can be controlled by a MIMO type controller having 8 inputs and 8 outputs for the 8 solenoid segments aligned in the phased axial array to control the rotor shaft dynamics.

Notably, the bearing assembly 10 can include as few as two electromagnetic solenoid segments, and as many as room permits. The individual axial length of each separate solenoid segment can be as axially thin as needed to meet the application requirements. Also, the segments do not need to have equal axial length. Each of the segments are axially spaced from another.

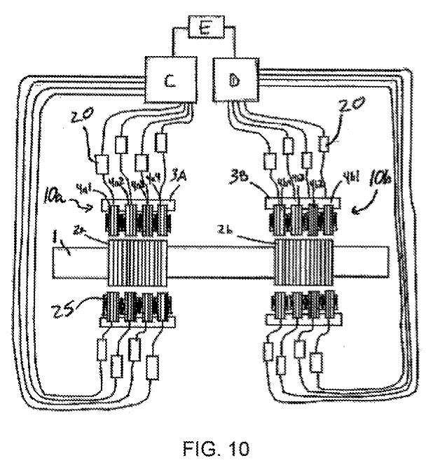

As illustrated by FIG. 10, a controller E is provided that is configured to coordinate control with each electromagnetic solenoid segments of the entire system. This system includes first and second magnetic bearing assemblies 10a and 10b that are configured to support the rotor 1 along the common axis of rotation 15. Each individual solenoid segment 4a1, 4a2, 4a3, 4a4, and 4b1, 4b2, 4b3, 4b4 of each assembly 10a, 10b respectively, are provided with a separate amplifier 20 such that each of the plurality of electromagnetic segments is in electrical communication with the amplifier and the controller. Optionally, the system can be provided with a decentralized control system wherein controllers C and D are provided to individual operate the bearing assemblies 10a, 10b, respectively. The controllers can be a microprocessor or a digital signal processor but his disclosure is not limited.

The controllers are configured to operate each solenoid segments individually along each axial plane such that precise control of the axial location of a support position of the bearing system is achieved. The centralized control system E can be used to direct the individual phased array segments in a coordinated manner for optimum rotor levitation control to stabilize rotor vibrations, for the particular operating conditions for various applications. The axial shift of the net force vector F can be performed automatically during the operation of the rotor such that the support position or bearing node between the bearing assembly and the rotor can occur anywhere within the axial length of the plurality of electromagnetic solenoid segments aligned in phased axial array.

With a coordinated control system E, C, D, the net force vector F of the segments aligned in the phased array can lay along any axial plane within the physical bounds of the outermost segments as they are supported within the stator housing 3. A such, the embodiments of the disclosed assembly and system of FIGS. 7, 8, 9 and 10 are only one such embodiment and various other configurations are contemplated by this disclosure.

Additionally, at least one feedback sensor 25 is provided within the bearing assembly 10. Optionally, a plurality of sensors can be provided wherein a sensor is located adjacent each solenoid segment of the array. The sensors 25 can be either co-located or non-collocated, or even shared between adjacent segments along the array. The feedback sensors 25 are adapted to measure an air gap between the rotor 1 and at least one of the plurality of electromagnetic solenoid segments 4 and provide a signal to the controller such that the controller is adapted to individually adjust the magnetic flux force vector F produced by each of the plurality of electromagnetic solenoid segments.

Additionally, each individual solenoid segment of the phased array can be either fully electromagnetic, or the type where a bias force is based partially on a permanent magnetic such that a control force is provided by an electromagnetic core.

In operation, the magnetic bearing assembly can automatically adjust the axial location of the support position of the rotor. The stator housing is provided with the plurality of electromagnetic solenoid segments arranged in the phased axial array in alignment with the axis of rotation of the rotor. The electromagnetic solenoid segments generate a magnetic flux force vector to support the rotor. Each segment individually generates a magnetic flux force that can be individually controlled or adjusted by the controller. The vector is the sum of each magnetic force generated by each of the segments. As the rotor is rotating along the axis of rotation, the magnetic bearing assembly supports the rotor. The feedback sensors are placed within the stator housing and measure the space or gap between the rotor laminations and at least one of the plurality of electromagnetic solenoid segments. The sensors provide a signal to the controller identifying the measurements of the gap. The controller processes the measurements received from each sensor and identifies if an adjustment to the axial location of the support position of the rotor is to be adjusted. The support position of the magnetic flux vector is then axially adjusted along the length of the array of electromagnetic solenoid segments. The controller is configured to individually control each of the electromagnetic solenoid segments such that an automatic adjustment the support position of the magnetic flux vector can be performed.

The power amplifiers are controlled to supply current to the electromagnets positioned radially about the rotor to create a bias force thereon. The sensors determine the effect the bias force has on the position of the rotor and notify the controller. A signal is then supplied to the amplifiers to modify the current provided to the electromagnetic solenoid segments to offset the bias forces as the rotor deviates from its desired position. The power amplifiers can be solid state devices which operate in a pulse width modulation configuration, but this configuration is not limited. Additionally, the bearing assembly of the instant disclosure can be supplied with a combined radial and thrust bearing configuration (not shown) to limit axial movement of the rotor relative to the bearing assembly.

The proposed design can work for rigid rotor shafts, but can also find particular usage with flexible and highly flexible rotor shaft designs, as well as a shaft that would experience changing parameters, ie. time dependent shaft mass properties, and/or time dependent geometrical properties that change shape over time or rotational speed.

This disclosed design has the ability the axially shift the support position automatically and electronically either axially inboard or outboard whichever better suits the operation of the shaft, from either or both bearing array, for a particular application. The axial shift of the support position can occur anywhere within the axial length of the phased axial array of solenoid segments.

The disclosed bearing design is able to adequately adjust to various changing inertia parameters due to different rotor masses, flexible rotors, or rotatable masses that become unbalanced over time. The bearing assembly allows for a much higher range of unbalanced forces that could be satisfactorily dealt with before having to shut down an assembly for maintenance. Additionally, vibration signatures of the bearing and rotor system can be controlled and automatically changed to improve efficiency or reduce noise as desired.

The exemplary embodiment has been described with reference to the preferred embodiments. Obviously, modifications and alterations will occur to others upon reading and understanding the preceding detailed description. It is intended that the exemplary embodiment be construed as including all such modifications and alterations insofar as they come within the scope of the appended claims or the equivalents thereof.

1. A magnetic bearing assembly for supporting an associated rotor comprising:
a stator housing configured to receive the associated rotor allowing the rotor to rotate along an axis of rotation therein; and
a plurality of electromagnetic solenoid segments arranged in a phased axial array that is axially aligned with the axis of rotation and supported by the stator, each of the plurality of electromagnet segments include at least one core and coil member.

2. The magnetic bearing assembly of claim 1, further comprising a controller configured to individually control each of the electromagnetic solenoid segments to axially adjust a support position along a length of the array of electromagnetic solenoid segments.

3. The magnetic bearing assembly of claim 2, further comprising at least one feedback sensor adapted to measure an air gap between the associated rotor and at least one of the plurality of electromagnetic solenoid segments and provide a signal to the controller wherein the controller is adapted to individually adjust a magnetic flux force vector produced by each of the plurality of electromagnetic solenoid segments.

4. The magnetic bearing assembly of claim 1, wherein there are four or more electromagnetic solenoid segments arranged in the phased axial array.

5. The magnetic bearing assembly of claim 1, wherein each of the electromagnetic solenoid segments arranged in the phased axial array is configured circumferentially around the associated rotor.

6. The magnetic bearing assembly of claim 1, wherein the core and coil member of each of the electromagnetic solenoid segments are aligned along a common plane and generally perpendicular to the axis of rotation.

7. The magnetic bearing assembly of claim 5, wherein each of the electromagnetic solenoid segments includes four core and coil members.

8. The magnetic bearing assembly of claim 2, wherein each of the plurality of electromagnetic segments is in electrical communication with an amplifier and the controller.

9. The magnetic bearing assembly of claim 1, wherein the core and coil member is generally U-shaped.

10. The magnetic bearing assembly of claim 1, wherein the core and coil member is generally E-shaped.

11. A magnetic bearing system for supporting a rotor comprising:
a first stator configured to receive an elongated rotor adapted to rotate along an axis of rotation;
a plurality of electromagnetic segments supported by the first stator and arranged in a phased axial array;
a second stator spaced from the first stator and configured to receive the elongated rotor adapted to rotate along the axis of rotation;
a plurality of electromagnetic segments supported by the second stator and arranged in a phased axial array; and
a controller configured to individually control each of the electromagnetic solenoid segments of the first stator and the second stator to adjust a magnetic flux force vector of the first stator and the second stator of the magnetic bearing system.

12. The magnetic bearing system of claim 11, wherein the elongated rotor includes at least one laminated portion mounted to the surface of the rotor and aligned with the plurality of electromagnetic segments of the first stator and the second stator.

13. The magnetic bearing system of claim 11, further comprising at least one feedback sensor adapted to measure an air gap between the elongated rotor and at least one of the plurality of electromagnetic solenoid segments and provide a signal to the controller such that the controller is adapted to automatically adjust the magnetic flux force vector produced by each of the plurality of electromagnetic solenoid segments.

14. The magnetic bearing system of claim 11, wherein there are four or more electromagnetic solenoid segments arranged in the phased axial array of the first and second stators.

15. The magnetic bearing system of claim 11, wherein each of the electromagnetic solenoid segments arranged in the phased axial array is configured circumferentially around the elongated rotor.

16. The magnetic bearing system of claim 11, wherein the electromagnetic solenoid segments each include a plurality of core and coil members that are aligned along a common plane generally perpendicular to the axis of rotation.

17. The magnetic bearing system of claim 16, wherein each of the electromagnetic solenoid segments includes four or more core and coil members.

18. The magnetic bearing system of claim 11, wherein each of the plurality of electromagnetic segments is in electrical communication with an amplifier and the controller.

19. A method of supporting a rotor within an active magnetic bearing assembly, the method comprising:
providing a stator housing with a plurality of electromagnetic solenoid segments arranged in a phased axial array in alignment with an axis of rotation of the rotor, the electromagnetic solenoid segments generate a magnetic flux force vector to support the rotor;
rotating the rotor along the axis of rotation;
measuring a space between the rotor and at least one of the plurality of electromagnetic solenoid segments; and
adjusting a support position of the magnetic flux vector axially along a length of the array of electromagnetic solenoid segments.

20. The method of claim 19 further comprising individually controlling each of the electromagnetic solenoid segments to automatically adjust the support position of the magnetic flux vector along the length of the array.
